(19) United States
(12) Patent Application Publication
(10) Pub. No.: US 2009/0045925 A1
(43) Pub. Date: Feb. 19, 2009

(54) System, Apparatus, and Method for Communicating Sensor Information of a System Component that is Disposed in a Hazardous Location

(75) Inventors: Vitaliy P. Demin, Saco, ME (US); Donald E. Watzke, JR., McFarland, WI (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FRANKLIN FUELING SYSTEMS, INC., Madison, WI (US)

(21) Appl. No.: 12/187,942

(22) Filed: Aug. 7, 2008

Related U.S. Application Data
(60) Provisional application No. 60/956,622, filed on Aug. 17, 2007.

(51) Int. Cl. G05B 11/01

(52) U.S. Cl. 340/310.11

(57) ABSTRACT

A system, apparatus, and method for communicating sensor information of a system component that is disposed in a hazardous location to a system controller including using an advanced hazardous location monitor/controller apparatus (data concentrator) along with power line communications to communicate diagnostic information obtained from a sensor located in a hazardous area to a central monitor/controller located in a non-hazardous area so that in-station diagnostics can be performed.

### CROSS-REFERENCE TO RELATED APPLICATION

This application claims priority from provisional application “In-Station Diagnostics Communication System” Application No. 60/956,622 filed Aug. 17, 2007, the contents of which is incorporated herein by reference.

### FEDERALLY SPONSORED RESEARCH OR DEVELOPMENT

Not Applicable.

### TECHNICAL FIELD

This invention generally relates to apparatuses, systems, and methods of monitoring and communicating sensor information from a sensor located in a hazardous area including a hazardous atmosphere, and/or hazardous equipment, and/or particles via sensors and communicating information from the sensor to an in-station diagnostics system while maintaining safety in the hazardous area.

### BACKGROUND OF THE INVENTION

Hazardous locations include hazardous areas where a potential for fire and explosion exist. Such a potential may exist because of flammable fuels, vapors or finely pulverized dusts being in the atmosphere, or because of the presence of easily ignitable fibers or other flying particles. Hazardous areas may also result from the normal processing of certain volatile chemicals, fuels, grains, and the like, or they may result from storage systems accidentally failing. It is also possible that a hazardous area is created when, during normal maintenance, volatile solvents or fluids vaporize to form an explosive atmosphere.

An example of hazardous areas includes areas of a fueling station, such as a conventional retail gasoline station. Fueling stations transport hazardous fuel materials from storage tanks to fuel dispensers. From the fuel dispensers people are able to fill fuel into their vehicles using the fuel nozzle of the dispenser. The fuel system typically has a fuel storage tank buried underground. The fueling system typically further includes multiple fuel dispensers, each dispenser typically having two dispensing points located opposite one another (i.e., two assemblies, each comprising a hose and dispensing nozzle, such as a HEALY™ Onboard Refueling Vapor Recovery (ORVR) nozzle.)

In transporting the fuel from the underground fuel storage tank to the dispensers, the fueling system uses a fuel delivery system. The fuel delivery system typically includes a fuel supply line to provide a common conduit for fuel delivery from the fuel storage tank to a branch fuel line associated with a respective one of each of the dispensers. Each of the branch fuel lines then splits into two fuel delivery lines to provide fuel to each of the dispensing points of a particular one of the dispensers. Each of the fuel delivery lines includes a fuel flow sensor. Each of the fuel flow sensors generates an electrical signal indicative of the quantity of fuel flowing through the meter, and thus dispensed into a vehicle. The signals from the fuel flow sensors are communicated to a master controller, typically located in a fueling station house.

A modern fueling system often also includes an assist vapor recovery system. Such a system is termed “assist” because it uses a vacuum pump typically located at each dispenser to assist in the removal of vapors. Similar to the fuel delivery system, the vapor recovery system typically includes a common vapor return line to provide a common vapor return conduit to return fuel vapor or ambient air from each of the dispensing points to the underground fuel storage tank. Each of the dispensing points has an associated dispensing point vapor return line. The two dispensing vapor return lines for each of the dispensing points associated with a respective one of the dispensers connect to a dispenser vapor return line. Each of the dispenser vapor return lines connects with the common vapor return line. A vacuum pump and a return flow sensor are placed in-line with each of the dispenser vapor return lines (i.e., a single vacuum pump and a single return flow meter are associated with each of the dispensers). A vapor pressure sensor is placed in-line with just one of the dispenser vapor return lines to provide a signal indication of the pressure in the fuel storage tank. The signals from the return flow sensors and the vapor pressure sensor are also electrically transmitted to the master controller.

The vacuum pumps create a vacuum to draw vapor (fuel vapor or ambient air) through the nozzles and ultimately into the fuel storage tank. The return flow meters generate an electrical signal indicative of vapor return flow through its associated dispenser vapor line towards the fuel storage tank.

The system typically also includes a fuel level sensor which generates a fuel level signal indicative of the level of fuel in the fuel storage tank. This signal is also communicated to the master controller. Knowing the level of fuel in the fuel storage tank, as well as the volume of the fuel storage tank, the master controller is able to determine the ullage space in the fuel storage tank (the amount the tank lacks of being full.)

As fuel is dispensed from the fuel storage tank to a vehicle fuel tank, fuel is moved one way while fuel vapor is displaced the opposite way. Fuel and fuel vapor are hazardous materials which are required to be maintained at a safety level. The combination of the fuel and fuel vapor with the electrical devices of the fueling system, described above, is a potentially hazardous combination. Typical methods used to reduce the danger of such a combination are described below.

Electrical equipment, such as sensors located in hazardous areas can be protected or prevented from releasing energy sufficient to ignite flammable fuels, vapors, or particles in the hazardous area. There are several methods of protection that are used when protecting equipment residing in hazardous areas. Two methods of safeguarding potentially hazardous equipment are the use of an explosion proofing technique and an intrinsic safety technique.

High power devices are usually kept safe in explosion proof equipment. Such explosion proof equipment reduce the danger of an explosion by utilizing an explosion proof enclosure that is designed strong enough to contain an explosion if the hazardous vapors were to enter the enclosure of the high power device and ignite. The enclosure of explosion proof equipment is designed to cool and vent the products of combustion in such a way that the surrounding atmosphere is not ignited. Explosion proof equipment is typically used to enclose high power devices such as motors, pumps, and the like. The wiring for explosion proofed devices must also be maintained in explosion proof conduits. Devices requiring such explosion proof equipment are commonly referred to as explosion proofed devices or explosion proof devices.

The intrinsic safety technique utilizes Intrinsically Safe (IS) equipment to maintain the safety of IS devices, which are “equipment and wiring which is incapable of releasing sufficient electrical or thermal energy under normal or abnormal conditions to cause ignition of a specific hazardous atmospheric mixture in its most easily ignited concentration,” as defined by ANSI/ISA RP12.06.01-1995 (R2002 Wiring Practices for Hazardous (Classified) Locations Instrumentation Part I: Intrinsic Safety (formerly ANSI/ISA RP12.6-1995).

An IS device, such as a sensor is kept safe by means of IS equipment, such as an IS barrier, which is circuitry that limits the amount of power delivered to an IS device to a level below that which would ignite the fuels, vapors, or particles. Power delivered to an IS device as well as control or measurement signals to and/or from an IS device must pass through the IS barrier.

Intrinsic safety is often used for low power devices, including different types of probes and sensors that are part of an in-station diagnostics system. The wiring for such IS devices must be separated from the wiring for non-IS devices. Thus the wiring is usually located in a separate conduit.

Besides the requirements that modern fuel stations must maintain certain safety levels for their hazardous areas, many modern retail fuel stations are also required to maintain in-station diagnostics (ISD) to monitor their fuel recovery systems. Increased environmental protection standards, such as the Stage II Vapor Recovery System requirements put forth by federal and local governments require fuel stations to continuously determine whether the fuel recovery system is working properly.

When vapor pressures build up in a fuel recovery system, the system lets out excess vapor pressure into the environment via a relief valve. The fuel station is required to include the monitoring of information, such as vapor pressure, vapor flow, and the quantity of fuel in an underground storage tank, for example, as accomplished by the vapor recovery system and its sensors, to reduce emissions into the environment. Fuel stations in need of upgrading to the Stage II vapor recovery requirements must implement the respective components including sensors while also implementing the safety devices (explosion proof equipment and IS equipment) needed to maintain the safety of these components. As discussed above, these sensors are located in hazardous areas, so that these sensors and their wiring require the use of intrinsic safety equipment. If the station is newly constructed, then separate underground IS conduit can readily be run to house the IS wiring needed to safeguard the sensors and their respective wiring.

In contrast, when adding Stage II in-station diagnostics to an existing fuel station that does not have already installed IS conduit for maintaining the safety of the connections to the sensors, the pavement and/or concrete must be cut. In other words, in the case where the sensors used for the in-station diagnostics are installed as a retrofit, there is no separate conduit available to hold the new intrinsically safe wiring which is required for the sensors.

To implement in-station diagnostics at an existing fuel station, an installer would need to cut the pavement and/or concrete to connect the sensors and their wiring located in, for example, underground sumps, to a building where a central controller capable of running processes for in-station diagnostics is located. The installation cost for such a site will be high and may exceed the cost of the system itself.

Disclosures of the present invention allow a reduction of the cost for installing in-station diagnostics for monitoring hazardous areas where retrofit installations are required.

Disclosures of the present invention presents an alternative data communications method and device for communicating sensor information from a hazardous area to a central controller which is located outside of the hazardous area.

### BRIEF DESCRIPTION OF THE DRAWINGS

FIG. 1 is an exemplary depiction of the background art used to maintain safety of a hazardous location site, such as a fueling station including a vapor recovery system and an in-station diagnostics system.

FIG. 2 is an exemplary depiction of a hazardous location monitoring and/or control system in accordance with an embodiment of the invention as applied to a fueling station.

FIG. 3 is an exemplary depiction of a data concentrator in accordance with an embodiment of the invention.

FIG. 4 is an exemplary depiction of two types of IS barrier embodiments in accordance with the invention.

### DETAILED DESCRIPTION OF THE INVENTION

While this invention is susceptible of embodiment in many different forms, there will be described herein in detail, a specific embodiment thereof with the understanding that the present disclosure is to be considered as an exemplification of the principles of the invention and is not intended to limit the invention to the specific embodiments illustrated.

In accordance with the present invention, a system, method, and apparatus is provided to permit communication between a device located in a hazardous area and a central monitor/controller device.

Embodiments of the present dislcosure reduce the cost of installing in-station diagnostics systems to monitor hazardous locations requiring retrofit installations of the intrinsic safety technology.

Also, in monitoring the hazardous location via the in-station diagnostics, the present disclosure provides increased communication capabilities of sensor information to local and remote as well as centralized monitors/controllers.

Another example of a benefit of the present disclosure is that disabling of a dispenser can be done locally by the disclosed data concentrator without having to disable the power to the dispenser as is required by conventional systems. In other words, the data concentrator can disable only a malfunctioning side of the dispenser while allowing fuel to be pumped from the other side.

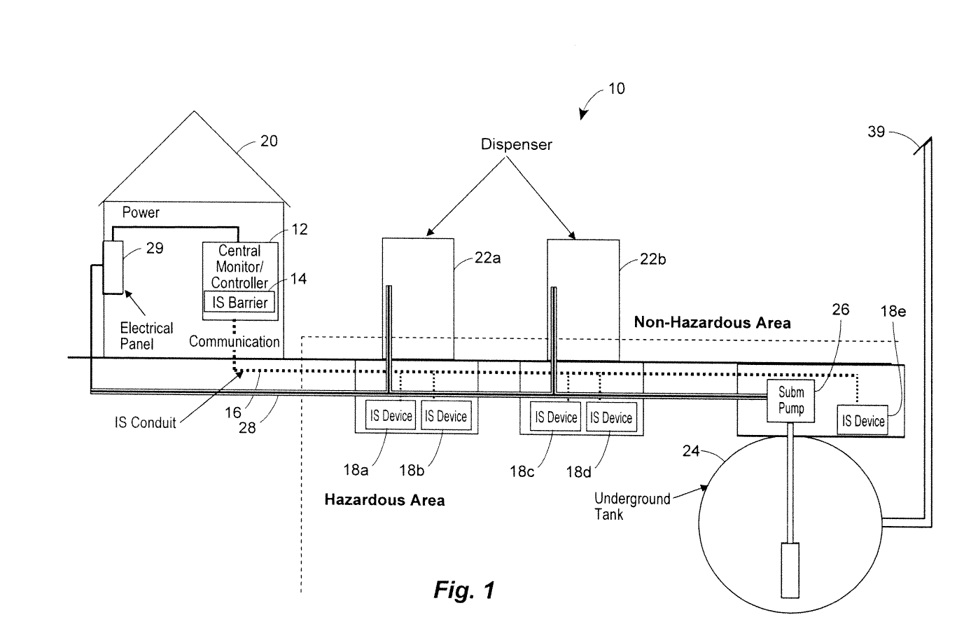

FIG. 1 illustrates a conventional system 10 for monitoring a hazardous location via in-station diagnostics by using a central monitor/controller 12 having an integrated IS barrier 14. This system requires IS conduits 16 for the wiring between the IS barrier and any IS device 18a-d to be monitored.

Further, FIG. 1 illustrates an example of a fuel station which has a hazardous area which generally includes a plurality of hazardous areas located around the sensors 18a-e that are monitored by these same sensors 18a-d. General components of a fuel station are shown. Easily visible are the fuel station building 20 and two fuel dispensers 22a, 22b. Underground is located a fuel tank 24 and its submersible pump 26. The submersible pump 26 is an example of a type of potentially hazardous high powered device that may explode. Thus, the pump 26 requires explosion proofing equipment.

As illustrated in FIG. 1, explosion proof conduit 28 contains wiring which runs between an electrical panel 29 located inside the fuel station building to a hazardous area where the dispensers 22a, 22b are located. Underground is where the potentially hazardous devices are typically located including the underground fuel tank 24, pump 26, and IS devices 18a-e.

FIG. 1 illustrates a fuel station after conventional implementation of the central monitor/controller 12. The central/monitor controller 12 performs in-station diagnostics to measure the amount of gasoline vapors that escape the fueling system's vapor recovery system thereby entering into the environment via a relief valve 39. The vapor recovery system collects gasoline vapors from a vehicle's fuel tank while a user dispenses gasoline products into his vehicle from a gasoline dispensing facility. Many regulatory bodies of federal, state, county, municipal and local governments, such as environmental agencies, air resource boards, and health departments have required that a specific standard of equipment is used to keep the amount of fuel vapors escaping into the environment at a minimum level.

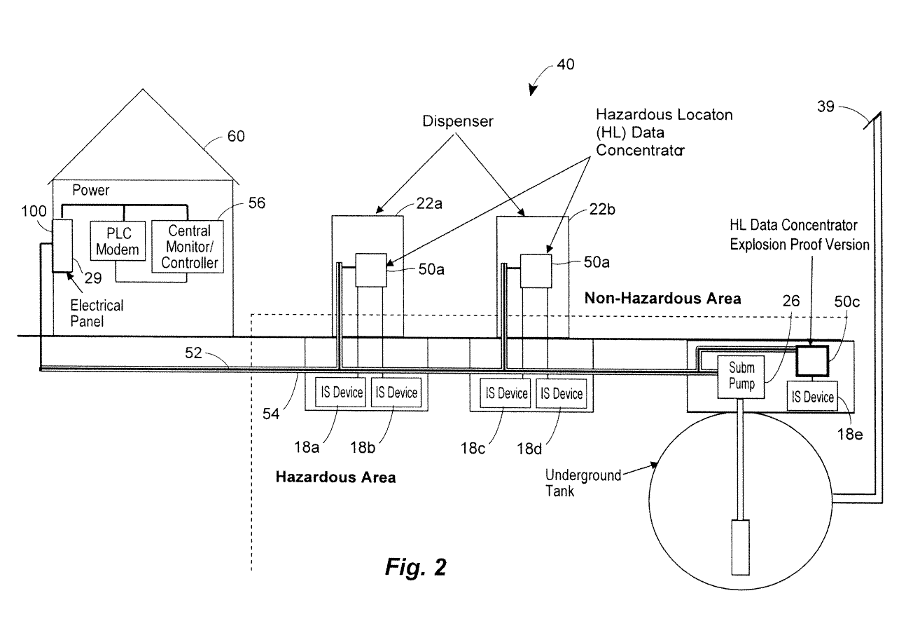

As discussed above, such a requirement is the Stage II vapor recovery specified system, which consists of special nozzles and coaxial hoses at each gasoline pump to capture vapors from the vehicle's fuel tank and to route the vapors to the station's underground or aboveground storage tank(s) during the refueling process. As shown, and discussed above, potentially hazardous devices (such as sensors 18a-e) of the intrinsically safe kind are part of the vapor recovery system and are located typically under the fuel dispensers 22a, 22b. In order to perform in-station diagnostics with the use of these sensors 18a-e, while maintaining a specified safety level, the background art necessitates the installation of additional IS conduit 16. This additional IS conduit 16 holds the IS wiring used to couple the central monitor 12 to the sensors 18a-d. The IS conduit 16 also separates the power line 52 (FIG. 2) from the electrical equipment in the IS conduit 16. In a retrofit situation, substantial cutting of the pavement and/or concrete 30 is required to install the additionally necessitated IS conduit 16.

FIG. 2 illustrates an embodiment 40 of the present invention. The system 40 includes a data central controller 56, a data concentrators 50a-c, and a power line 52. The power line provides power to the system and also provides a communication link between the data concentrator 50 and the central controller 56.

The system 40 may have a data concentrator 50 (50a, 50b) located at each of the dispensers 22a, 22b and a data concentrator 50c located underground by a pump 26, or anywhere else such as, underground, at the fuel station building 60, outside the dispenser 22, etc. as long as the functionality of the data concentrator remains.

The fuel station building 60 may house a central monitor/controller 56 which is configured to receive the sensor information via the power line 52, which is coupled to the data concentrator 50. The power line 52 between the data concentrator and the power source 100 is located within explosion proof conduit 54. The power source 100 is typically located at the fuel station building 60.

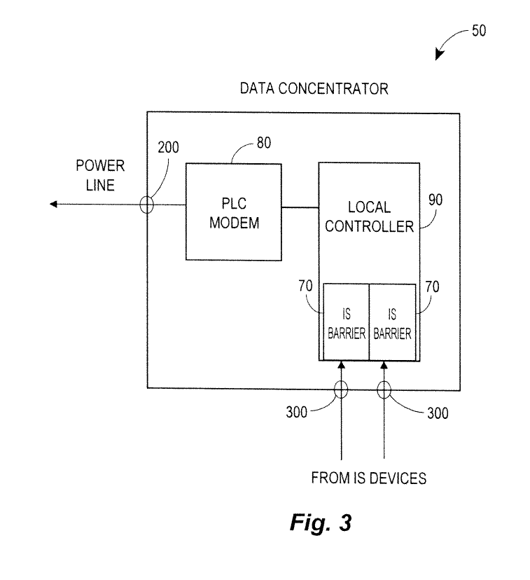

For example, operation of the system 40 includes the sensor 18a passing information through an IS barrier 70 (FIG. 3.) From the IS barrier 70 the sensor information may be processed by the data concentrator 50. The data concentrator 50 sends the sensor information to the central controller 56 for in-station diagnostics via the power line connection 52. In this way, less breaking of pavement and concrete is needed to couple the sensor information from the sensor 18a to the data concentrator 50a. The background art requires more breaking of pavement/concrete to couple the sensor information from the sensor to the IS barrier located at the fuel station building 60 as shown in FIG. 1 due to the implementation of the IS conduit.

Other information, such as the vapor pressure sensor information and the fuel level sensor information may also be sent to the central controller 56 at the fuel station building 60 via the embodiments of the data concentrator 50 and the power line 52. Potentially hazardous devices that require IS barriers inlcude vapor flow meter sensors, vapor pressure sensors, and fuel tank level sensors (IS devices.) These devices are typically located in sumps associated with fuel dispensers or fuel tanks. The sumps are typically located in hazardous areas.

In the embodiment illustrated in FIG. 2, the hazardous location data concentrator 50 is housed by the fuel dispenser (22a, 22b) housing. The hazardous location data concentrator 50 may be located elsewhere in the system, such as underground, at the fuel station building 60, outside the dispenser 22, etc. as long as the functionality of the data concentrator remains so that the sensor information is transmitted from the sensor to the central monitor/controller 56 via the power line 52. The central monitor/controller is shown in the fuel station 60. The central monitor/controller 56 may be disposed elsewhere as long as it includes the Power Line Communication (PLC) modulator 80, such as the PLC modem (FIG. 3) to receive the sensor information from, for example, the sensor 18a via the power line 52.

As illustrated in FIG. 3, one embodiment of the data concentrator 50 includes a PLC modulator, such as the PLC modem 80, at least one intrinsic barrier device 70, a local controller 90, a communication line interface 300, and a power line interface 200. The PLC modulator 80 modulates the sensor information received by, for example, sensor 18a so that this sensor information can be sent over the power line 52 to the central monitor/controller 56. The PLC modulator includes analog and/or digital modulators. The PLC modulator, such as the PLC modem 80 is configured to communicate power line protocols, such as the Homeplug Command and Control standard (HPCC).

Yitran Communications Ltd. produces a HPCC technology that is also licensed by Renesas Technology and may also be implemented with the embodiments of the invention. The PLC modulator may perform modulation on the signal prior to or after processing or control of the sensor information by the local controller 90.

Alternatively, the local controller 90 is not required as part of the data concentrator 50. In other words, the sensor information may be regulated by the IS barrier 70 and modulated by the PLC modulator, such as the PLC modem 80 without any further processing and then transmitted by the modem 80 via a power line interface 200. The modulated sensor information may then be processed at the central monitor/controller 56.

Other embodiments of the data concentrator 50 may have the internally described functionality existing in separate housing. Other embodiments may include additional devices in the hazardous location data concentrator such as any one or more of the group consisting of a storage device, other barrier devices, indicators, diagnostics interfaces, other interfaces, air or vapor (A) and liquid (L) ratios (A/L ratio) calculation processes, sampling of tank ullage pressure data processes, and the like.

Alternatively, one or more of a plurality of data concentrators 50 may take on the processing functionality of the central controller/monitor 56 in performing in-station diagnostics, so that the remote central monitor/controller is not required for the system 40. Also, in-station diagnostics processing may be distributed amongst any combination of data concentrators 50 and a central monitor/controller 56 as long as sensor information is communicated via the power line 52.

Still other embodiments may have the hazardous location data concentrator 50 be a standalone device or a device that may plug into another device, such as a module, and/or may be communicatively coupled to the central monitor/controller 56 in accordance with convention including via a central or distributed network scheme.

FIG. 2 illustrates one embodiment of the central monitor/controller 56. Other embodiments of the central/monitor controller 56 may have the central monitor/controller 56 housed together with the PLC modulator, such as the illustrated PLC modem. Also, the communication link shown between the central/monitor controller 56 and the PLC modem may be removed and all communications between the devices may occur over the power line 59.

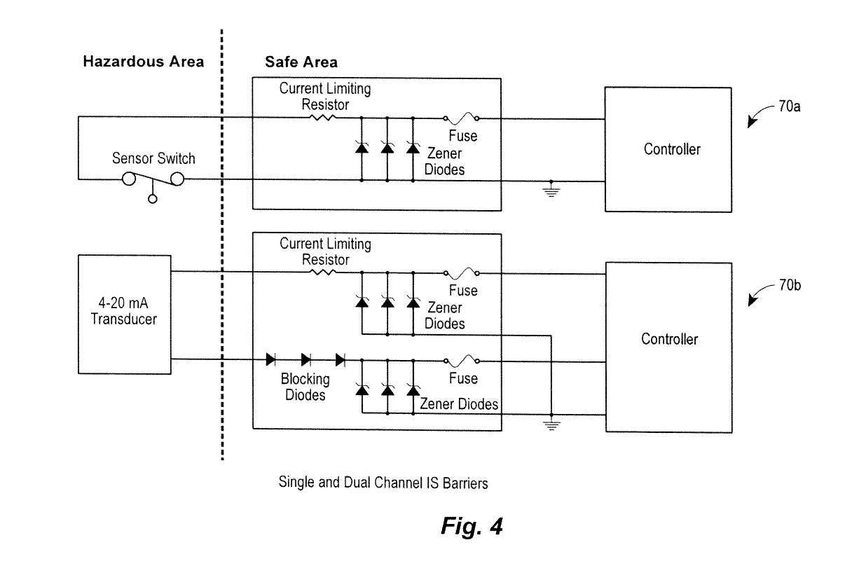

FIG. 4 illustrates two embodiments 70a, 70b of the IS barriers 70 in accordance with the invention. These circuits may be used to limit the voltage and current going to the sensors 18a-e so that if any dangerous current level is reached the sensor circuitry will maintain safety levels via, for example, a fuse.

Other embodiments may have the IS barrier 70 disposed outside the hazardous location data concentrator 50, as can be appreciated by those of ordinary skill in the art.

What is claimed is:

1. A hazardous location data concentrator configured to communicate sensor information from a sensor device of a fueling system, the sensor device found in a hazardous area, to a remote controller device of the fueling system, the remote controller found in a non-hazardous area, the hazardous location data concentrator comprising:
a local controller coupled to an intrinsically safe barrier;
a communication line interface configured to couple the sensor device of the fueling system with the local controller via the intrinsically safe barrier;
a power line communication modulator configured to modulate the sensor information obtained by the local controller via a power line interface, the power line interface configured to couple a power source with the power line communication modulator;
wherein the power line interface is configured to communicate the sensor information obtained by the local controller to the remote controller device of the fueling system.

2. A hazardous location data concentrator according to claim 1, wherein the communication line interface is configured to retrofit to the sensor device.

3. A hazardous location data concentrator according to claim 1, wherein the remote controller is configured to receive sensor information from a plurality of sensor devices.

4. A hazardous location data concentrator according to claim 1, wherein any one of the local controller or the remote controller further comprise an in-station diagnostics module.

5. A hazardous location data concentrator according to claim 1, further comprising a disabling unit configured to disable a malfunctioning unit of a dispenser of the fueling system without having to disable power to the dispenser.

6. A hazardous location data concentrator according to claim 1, wherein the sensor information includes information from one of a group comprising a flow meter sensor, a vapor pressure sensor and a fuel tank level sensor.

7. A hazardous location data concentrator according to claim 1, wherein the concentrator is configured to be appended into the central controller.

8. A hazardous location data concentrator according to claim 1, wherein the concentrator is enclosed in an explosion proof barrier and a power line coupled to the power line interface is enclosed in an explosion proof conduit.

9. A hazardous location data concentrator according to claim 1, wherein the power line interface supports power line communication protocols.

10. A hazardous location data receiver configured to receive sensor information from a fueling system having at least a portion of the fueling system located in a hazardous area, the hazardous location data receiver comprising:
a processor configured to receive the sensor information from a sensor device located in the hazardous area, the sensor device coupled to an intrinsically safe barrier, the intrinsically safe barrier configured to maintain electric energy of the sensor device within a safe level, the processor further configured to process the sensor information in order to produce in-station diagnostics;
a power line communication modulator coupled to the processor, and configured to demodulate the sensor information;
a power line interface configured to couple a power source with the power line communication modulator, wherein the power line interface is coupled to a power line, the power line is partially encapsulated in an explosion proof conduit for the portion of the fueling system located in the hazardous area.

11. A hazardous location data receiver according to claim 10, wherein the power line interface is configured to retrofit to the sensor device.

12. A hazardous location data receiver according to claim 10, wherein the receiver is configured to receive sensor information from a plurality of sensor devices.

13. A hazardous location data receiver according to claim 10, further comprising an in-station diagnostics module.

14. A hazardous location data receiver according to claim 10, further comprising a disabling unit configured to disable a malfunctioning unit of a dispenser of the fueling system without having to disable power to the dispenser.

15. A hazardous location data receiver according to claim 10, wherein the sensor information includes information from one of a group comprising a flow meter sensor, a vapor pressure sensor and a fuel tank level sensor.

16. A hazardous location data receiver according to claim 10, wherein the receiver is configured to be appended into a pre-existing central monitor of the fueling system.

17. A method of communicating sensor information from a sensor, of a fueling system, found in a hazardous area, to a remote controller device of the fueling system, the remote controller found in a non-hazardous area, the method comprising:
maintaining intrinsic safety of circuitry coupling the sensor information originating from the sensor in the hazardous area to a local controller in the non-hazardous area;
explosion proofing a portion of a power line located in a hazardous area, the power line configured to power at least one component of the fueling system;
communicating the sensor information from the sensor via the circuitry to the local controller;
receiving the sensor information at the local controller via an intrinsically safe barrier coupled to the circuitry;
sending the sensor information from the local controller to a remote controller via the power line.

18. A method according to claim 17, further comprising retrofitting the fueling system with the local controller.

19. A method according to claim 17, further comprising sending the sensor data to a centralized monitor.

20. A method according to claim 17, further comprising performing in-station diagnostics of the fueling system.

21. A method according to claim 17, further comprising disabling a malfunctioning unit of a dispenser of the fueling system without having to disable power to the dispenser.

22. A hazardous location data concentrator configured to communicate sensor information from a sensor device of a fueling system, found in a hazardous area, to a remote controller device of the fueling system, the remote controller found in a non-hazardous area, the concentrator comprising:
means for maintaining intrinsic safety of circuitry coupling the sensor information originating from the sensor in the hazardous area to a local controller in the non-hazardous area;
means for explosion proofing a portion of a power line located in a hazardous area, the power line configured to power at least one component of the fueling system;
means for communicating the sensor information from the sensor via the circuitry to the local controller;
means for receiving the sensor information at the local controller via an intrinsically safe barrier coupled to the circuitry; and
means for sending the sensor information from the local controller to a remote controller via the power line.

23. For a fueling system for delivering fuel to a vehicle, the system including a fuel dispenser housing and a Stage II vapor recovery system, the vapor recovery system including an intrinsically safe vapor flow sensor and an intrinsically safe vapor pressure sensor, a monitoring system for monitoring the vapor flow sensor and the vapor pressure sensor, the monitoring system comprising:
a controller;
power line providing power to the controller; and
a data concentrator disposed in the dispenser housing and coupled to the power line, the data concentrator configured to received information from the sensors and to communicate the received information to the controller, the data concentrator including an intrinsically safe barrier for communicatively coupling the data concentrator to the sensors, and circuitry communicatively coupled between the intrinsically safe barrier and the power line for receiving electrical signals from the sensors and transmitting the received signals to the controller over the power line.

24. For a fueling system for fueling a vehicle, the fueling system including a controller, an intrinsically safe sensor located in a hazardous area, and a power line providing power to the controller, a data concentrator coupled to the power line and configured to communicate information from the sensor to the controller, the concentrator comprising:
an intrinsically safe barrier for communicatively coupling the data concentrator to the sensor; and
circuitry communicatively coupled between the intrinsically safe barrier and the power line for receiving electrical signals from the sensor and transmitting the received signals to the controller over the power line.

25. A concentrator according to claim 24, wherein the fueling system includes a fuel dispenser housing and the data concentrator is located in the dispenser.

26. A concentrator according to claim 26, wherein the circuitry includes a local controller coupled to the intrinsically safe barrier, the local controller coupled to a power line communication modulator configured to communicate the information from the sensor to the controller.
